(19) United States
(12) Patent Application Publication
(10) Pub. No.: US 2007/0035586 A1
(43) Pub. Date: Feb. 15, 2007

(54) Printing devices and related devices and methods

(76) Inventors: Samuel E. Apkarian, Antrim, NH (US); Robert J. Bowblis, Swanzey, NH (US); Alan H. Boyer, Spofford, NH (US); Jeffrey B. Brooks, Sullivan, NH (US); Benjamin J. Brown, Keene, NH (US); Arne Johannessen, Northfield, MA (US); Richard J. Larson JR., Walpole, NH (US)

Correspondence Address: FISH & RICHARDSON PC, P.O. BOX 1022, MINNEAPOLIS, MN, 55440-1022, US

(21) Appl. No.: 11/501,346

(22) Filed: Aug. 9, 2006

Related U.S. Application Data
(60) Provisional application No. 60/706,865, filed on Aug. 10, 2005.

(51) Int. Cl. B41J 2/16; B41J 2/14

(52) U.S. Cl. 347/52

(57) ABSTRACT

Devices and methods are described that utilize material-handling systems in which material in the systems has enhanced stability.

### CROSS-REFERENCE TO RELATED APPLICATION

This application claims priority from U.S. Provisional Patent Application Ser. No. 60/706,865, filed on Aug. 10, 2005, which is incorporated herein by reference in its entirety.

### TECHNICAL FIELD

This invention relates to printing devices, and to related devices and methods.

### BACKGROUND

Some radiation-curable, e.g., UV-curable, jetting inks are liquid at room temperature. To ensure correct jetting viscosity, these liquid radiation-curable inks are often jetted above room temperature, e.g., 30° C. or more, e.g., 40° C. Such inks can be jetted onto substantially non-porous substrates, e.g., plastic pen barrels or circuit boards, or porous substrates. When such liquid radiation-curable inks are jetted onto a substrate, e.g., paper or plastic, to form an image, phenomena such as bleed-through, pinhole wetting and fisheyes due to the wetting characteristics of the liquid can result in inadequate ink coverage and overall poor print quality. One solution that is often used to reduce wicking is to treat the substrate to make it less porous. However, some inks do not perform well with such treatments. Another solution to minimizing wicking and bleed-through is to rapidly surface cure the ink, but often this does not completely eliminate wicking and bleed-through, and can require cumbersome and expensive equipment.

“Hybrid-F” radiation-curable jetting inks, i.e., those that polymerize by radical and/or cationic mechanisms to give polymer networks, are often described as “semi-solid inks,” and are more viscous at room temperature than at jetting temperature. Hybrid-F inks are available from Aellora™, e.g., under the tradename VistaSpec™ HB. Typically, these inks are jetted at elevated temperatures, e.g., above 60° C. or above 65° C., to lower ink viscosity to an appropriate jetting viscosity. After jetting hybrid-F ink, e.g., through a piezoelectric drop-on-demand inkjet printhead, ink viscosity rapidly increases as the ink cools on contact with the substrate. Once cooled to about room temperature, the hybrid-F ink does not flow without shear, allowing “wet-on-wet” printing without intermediate curing stages. Since the hybrid-F ink does not substantially flow at room temperature, wetting defects can be reduced, often reducing or eliminating the need for substrate surface treatments.

Liquid and hybrid-F radiation-curable inks typically contain inhibitors, e.g., hydroquinone (HQ) or hydroquinone monomethyl ether (MEHQ), which help to stabilize the ink, e.g. inhibit premature polymerization of the ink. Premature polymerization is problematic since it can clog small and delicate ink flow pathways and/or jetting nozzles within a print engine. While many inhibitors require the presence of oxygen to be effective, anaerobic inhibitors are also available that do not require the presence of oxygen to be effective.

### SUMMARY

This invention relates to printing devices, and to related devices and methods.

Generally, devices and methods are described that utilize material-handling systems that maximize the stability of the material, e.g., an ink or a clear overcoat material. For example, ink-handling systems can reduce premature polymerization, resulting in systems with a reduced tendency to clog and foul.

In one aspect, the invention features a method of handling an ink that includes conveying an ink having an initial viscosity and including a radiation-curable material along an ink pathway from an ink supply to a jetting module that includes a pressure chamber. The pressure chamber is pressurized to eject ink from the jetting module. A viscosity of the ink in the pressure chamber is not more than fifty percent higher than the initial viscosity of the ink, both viscosities being measured at jetting temperature. In some embodiments, the viscosity of the ink in the pressure chamber is not more than twenty five percent higher than the initial viscosity, e.g., not more than fifteen percent, not more than ten percent, not more than five percent, or not more than 1 percent.

In some embodiments, the ink pathway has a first portion configured to maintain the ink below a first temperature and a second portion downstream of the first portion configured to heat the ink above the first temperature.

The ink can be, e.g., any ink described herein. For example, in some embodiments, the ink is a liquid or a hybrid-F radiation-curable ink. The radiation-curable material can include a cross-linkable material, such as a cross-linkable monomer and/or an oligomer. The cross-linkable monomer can be or can include, e.g., a diacrylate, a diarylate or mixtures of these. For example, the cross-linkable monomer can be (2-hydroxyethyl)-isocyanurate triacrylate, dipentaerythritol pentaacrylate, ethoxylated trimethylolpropane triacrylates, propoxylated glyceryl triacrylate, propoxylated pentaerythritol tetraacrylate, or mixtures of these.

In another aspect, the invention features a method of handling an ink that includes conveying an ink comprising a radiation-curable material along an ink pathway from an ink supply to a jetting module including a pressure chamber. The pressure chamber is pressurized to eject ink from the jetting module. A residence time of the ink, measured from the ink supply to the pressure chamber, is less than about four hours, e.g., less than two hours, less than one hour, or less than 30 minutes.

In some embodiments, the ink pathway has a first portion configured to maintain the ink below a first temperature and a second portion downstream of the first portion configured to heat the ink above the first temperature.

The ink can be, e.g., any ink described herein. For example, in some embodiments, the ink is a liquid or a hybrid-F radiation-curable ink. The radiation-curable material can include a cross-linkable material, such as a cross-linkable monomer and/or an oligomer. The cross-linkable monomer can be or can include, e.g., a diacrylate, a diarylate or mixtures of these. For example, the cross-linkable monomer can be (2-hydroxyethyl)-isocyanurate triacrylate, dipentaerythritol pentaacrylate, ethoxylated trimethylolpropane triacrylates, propoxylated glyceryl triacrylate, propoxylated pentaerythritol tetraacrylate, or mixtures of these.

In another aspect, the invention features a method of handling ink that includes conveying an ink that includes a radiation-curable material, e.g., a UV-curable material, along an ink pathway from an ink supply to a printing module. The ink pathway includes a first portion configured to maintain the ink below a first temperature, and a second portion downstream of the first portion configured to heat the ink above the first temperature. The ink is heated in the second portion such that substantially no thermal polymerization of the ink occurs during the heating in the second portion.

In some embodiments, the ink pathway further includes a third portion downstream of the second portion.

The ink can be, e.g., any ink or mixtures of inks described herein. The radiation-curable material can include, e.g., a cross-linkable material, such as a cross-linkable monomer and/or an oligomer. For example, the cross-linkable monomer can be a diacrylate, a diarylate, or mixtures of these. In specific embodiments, the cross-linkable monomer is (2-hydroxyethyl)-isocyanurate triacrylate, dipentaerythritol pentaacrylate, ethoxylated trimethylolpropane triacrylates, propoxylated glyceryl triacrylate, propoxylated pentaerythritol tetraacrylate, or mixtures of these.

If desired, the ink can further include a wax or a resin and/or a polymerization inhibitor, such as hydroquinone.

The conveying can be, e.g., accomplished with a screw.

In some embodiments, the heating of the ink in the second portion increases ink temperature exiting the second portion to a second temperature that is within 10° C. of ink residing in a reservoir of the printing module.

In some embodiments, the ink pathway is permeable to air.

The heating can be accomplished with ultrasound, a heat exchanger, e.g., a thin-walled heat exchanger, microwaves, a resistive heating material, a PTC thermistor, or by friction. When microwaves are utilized to heat, the ink can include a microwave energy absorbing material to aid in its heating. If desired, the heat source can be a moving heat source.

In some embodiments, the heating of the ink in the second portion is performed progressively, such that a temperature of the ink increases as the ink travels through the second portion.

In some embodiments, the radiation that cures the radiation-curable material is ultraviolet light, e.g., having a wavelength of between about 200 nm and 500 nm.

In some embodiments, a ratio of a distance traveled by the ink through the first portion to a distance traveled by the ink in the second portion is greater than about 100 to 1, e.g., greater than 250 to 1.

In another aspect, the invention features a method of handling ink that includes conveying an ink that includes a radiation-curable material, e.g., a UV-curable material, along an ink pathway from an ink supply to a printing module. The ink pathway includes a first portion configured to maintain the ink below a first temperature, and a second portion downstream of the first portion configured to heat the ink above the first temperature. The ink is heated in the second portion. A residence time of the ink being conveyed through the second portion is less than 60 minutes, e.g., less than 30 minutes, or less than 15 minutes.

In some embodiments, the ink pathway further includes a third portion downstream of the second portion.

The ink can be, e.g., any ink or mixtures of inks described herein. The radiation-curable material can include, e.g., a cross-linkable material, such as a cross-linkable monomer and/or an oligomer. For example, the cross-linkable monomer can be a diacrylate, a diarylate, or mixtures of these. In specific embodiments, the cross-linkable monomer is (2-hydroxyethyl)-isocyanurate triacrylate, dipentaerythritol pentaacrylate, ethoxylated trimethylolpropane triacrylates, propoxylated glyceryl triacrylate, propoxylated pentaerythritol tetraacrylate, or mixtures of these.

If desired, the ink can further include a wax or a resin and/or a polymerization inhibitor, such as hydroquinone.

The conveying can be, e.g., accomplished with a screw.

In some embodiments, the heating of the ink in the second portion increases ink temperature exiting the second portion to a second temperature that is within 10° C. of ink residing in a reservoir of the printing module.

In some embodiments, the ink pathway is permeable to air.

The heating can be accomplished with ultrasound, a heat exchanger, e.g., a thin-walled heat exchanger, microwaves, a resistive heating material, a PTC thermistor, or by friction. When microwaves are utilized to heat, the ink can include a microwave energy absorbing material to aid in its heating. If desired, the heat source can be a moving heat source.

In some embodiments, the heating of the ink in the second portion is performed progressively, such that a temperature of the ink increases as the ink travels through the second portion.

In some embodiments, the radiation that cures the radiation-curable material is ultraviolet light, e.g., having a wavelength of between about 200 nm and 500 nm.

In some embodiments, a ratio of a distance traveled by the ink through the first portion to a distance traveled by the ink in the second portion is greater than about 100 to 1, e.g., greater than 250 to 1.

In another aspect, the invention features an apparatus for printing on a substrate. The apparatus includes a printing module configured to print an ink that includes a radiation-curable material, e.g., a UV-curable material. An ink supply module has an ink pathway from an ink supply to the printing module. The ink pathway includes a first portion configured to maintain the ink below a first temperature, and a second portion downstream of the first portion configured to heat the ink above the first temperature as it is conveyed through the second portion. Substantially no thermal polymerization of the ink occurs during the heating in the second portion.

In some embodiments, the ink pathway further includes a third portion downstream of the second portion.

The ink can be, e.g., any ink or mixtures of inks described herein. The radiation-curable material can include, e.g., a cross-linkable material, such as a cross-linkable monomer and/or an oligomer. For example, the cross-linkable monomer can be a diacrylate, a diarylate, or mixtures of these. In specific embodiments, the cross-linkable monomer is (2-hydroxyethyl)-isocyanurate triacrylate, dipentaerythritol pentaacrylate, ethoxylated trimethylolpropane triacrylates, propoxylated glyceryl triacrylate, propoxylated pentaerythritol tetraacrylate, or mixtures of these.

If desired, the ink can further include a wax or a resin and/or a polymerization inhibitor, such as hydroquinone.

The conveying can be, e.g., accomplished with a screw.

In some embodiments, the heating of the ink in the second portion increases ink temperature exiting the second portion to a second temperature that is within 10° C. of ink residing in a reservoir of the printing module.

In some embodiments, the ink pathway is permeable to air.

The heating can be, e.g., accomplished with ultrasound, a heat exchanger, e.g., a thin-walled heat exchanger, microwaves, a resistive heating material, a PTC thermistor, or by friction. When microwaves are utilized to heat, the ink can include a microwave energy absorbing material to aid in its heating. If desired, the heat source can be a moving heat source.

In some embodiments, the heating of the ink in the second portion is performed progressively, such that a temperature of the ink increases as the ink travels through the second portion.

In some embodiments, the radiation that cures the radiation-curable material is ultraviolet light, e.g., having a wavelength of between about 200 nm and 500 nm.

In some embodiments, a ratio of a distance traveled by the ink through the first portion to a distance traveled by the ink in the second portion is greater than about 100 to 1, e.g., greater than 250 to 1.

In another aspect, the invention features an apparatus for printing on a substrate that includes a printing module configured to print an ink that includes a radiation-curable material, e.g., a UV-curable material. An ink supply module has an ink pathway from an ink supply to the printing module. The ink pathway includes a first portion configured to maintain the ink below a first temperature, and a second portion downstream of the first portion configured to heat the ink above the first temperature as it is conveyed through the second portion. A residence time of ink being conveyed through the second portion is less than 60 minutes, e.g., less than 30 minutes or less than 15 minutes.

In some embodiments, the ink pathway further includes a third portion downstream of the second portion.

The ink can be, e.g., any ink or mixtures of inks described herein. The radiation-curable material can include, e.g., a cross-linkable material, such as a cross-linkable monomer and/or an oligomer. For example, the cross-linkable monomer can be a diacrylate, a diarylate, or mixtures of these. In specific embodiments, the cross-linkable monomer is (2-hydroxyethyl)-isocyanurate triacrylate, dipentaerythritol pentaacrylate, ethoxylated trimethylolpropane triacrylates, propoxylated glyceryl triacrylate, propoxylated pentaerythritol tetraacrylate, or mixtures of these.

If desired, the ink can further include a wax or a resin and/or a polymerization inhibitor, such as hydroquinone.

The conveying can be, e.g., accomplished with a screw.

In some embodiments, the heating of the ink in the second portion increases ink temperature exiting the second portion to a second temperature that is within 10° C. of ink residing in a reservoir of the printing module.

In some embodiments, the ink pathway is permeable to air.

The heating can be, e.g., accomplished with ultrasound, a heat exchanger, e.g., a thin-walled heat exchanger, microwaves, a resistive heating material, a PTC thermistor, or by friction. When microwaves are utilized to heat, the ink can include a microwave energy absorbing material to aid in its heating. If desired, the heat source can be a moving heat source.

In some embodiment, the heating of the ink in the second portion is performed progressively, such that a temperature of the ink increases as the ink travels through the second portion.

In some embodiments, the radiation that cures the radiation-curable material is ultraviolet light, e.g., having a wavelength of between about 200 nm and 500 nm.

In some embodiments, a ratio of a distance traveled by the ink through the first portion to a distance traveled by the ink in the second portion is greater than about 100 to 1, e.g., greater than 250 to 1.

Ultraviolet radiation, e.g., electromagnetic energy with a wavelength from about 200 nm to about 400 nm, and visible light, e.g., electromagnetic energy with a wavelength from about 400 nm to about 700 nm, or a combination thereof are examples of radiation sources.

Embodiments may have one or more of the following advantages. Generally, the material, such as ink, in the material-handling systems has enhanced stability, e.g., a reduced tendency to polymerize and/or exhibits a stable viscosity. For example, the ink handling systems have a reduced tendency to thermally polymerize ink flowing through the ink flow pathways, which can result in a system having enhanced ink flow and jetting performance. Such ink handling systems have a reduced tendency for ink flow pathway blockage, nozzle clogging, and/or valve blockage. This in turn reduces cleaning downtime and improves printing efficiency. Keeping the often small and delicate flow paths and/or nozzles clear of environmental containments allows the ink to flow through the flow paths with reduced resistance. Lower resistance to flow enables, e.g., a more rapid refilling of the pumping chamber. For example, rapidly refilling the pumping chamber can translate into an ability to eject drops at a higher frequency, e.g., 10 kHz, 25 kHz, 50 kHz or higher, e.g., 75 kHz. Higher frequency printing can improve the resolution of ejected drops by increasing the rate of drop ejection, reducing size of the ejected drops, and enhancing velocity uniformity of the ejected drops. In addition, keeping nozzles and/or flow paths clear of polymerized ink can reduce ejection errors, such as mis-fires or trajectory errors, and thereby improve overall print quality.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference herein in their entirety. In case of conflict, the present specification, including definitions, will control. In addition, the materials, methods, and examples are illustrative only and not intended to be limiting.

Other features and advantages of the invention will be apparent from the following detailed description, and from the claims.

### DESCRIPTION OF DRAWINGS

FIG. 1 is a perspective schematic view of a printing apparatus including a printing module and ink supply module.

FIGS. 1A and 1B are perspective front and back views of a printhead, respectively.

FIG. 2 is an enlarged perspective view of a portion of a printhead.

FIG. 3 is a block diagram of the printing apparatus of FIG. 1, illustrating various heating modes.

FIG. 4 is a schematic view of ink being heated in an ink pathway by microwaves.

FIG. 5 is a cross-sectional view of a high-pressure ram conveying ink through a disk having a plurality of torturous flow paths.

FIG. 6 is a top view of the disk of FIG. 5.

FIG. 7 is a graph of resistance versus temperature for a PTC thermistor.

### DETAILED DESCRIPTION

Generally, devices and methods are described that utilize ink handling systems in which ink in the systems has a reduced tendency to thermally polymerize during conveyance. Described systems can, e.g., reduce ink flow pathway blockages and nozzle clogging.

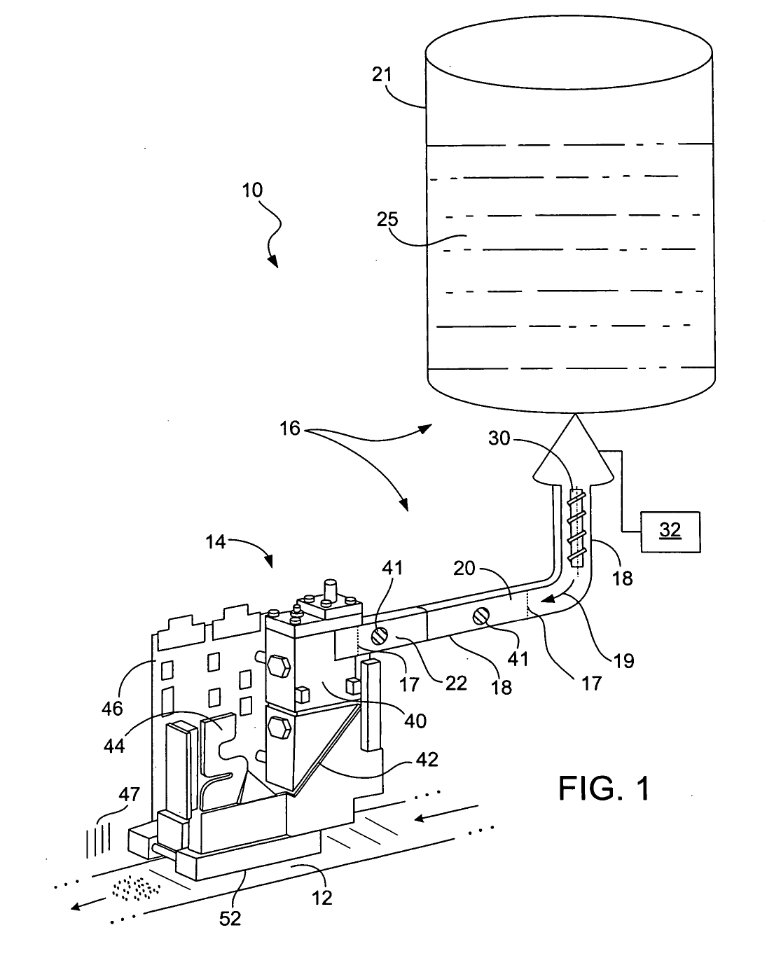

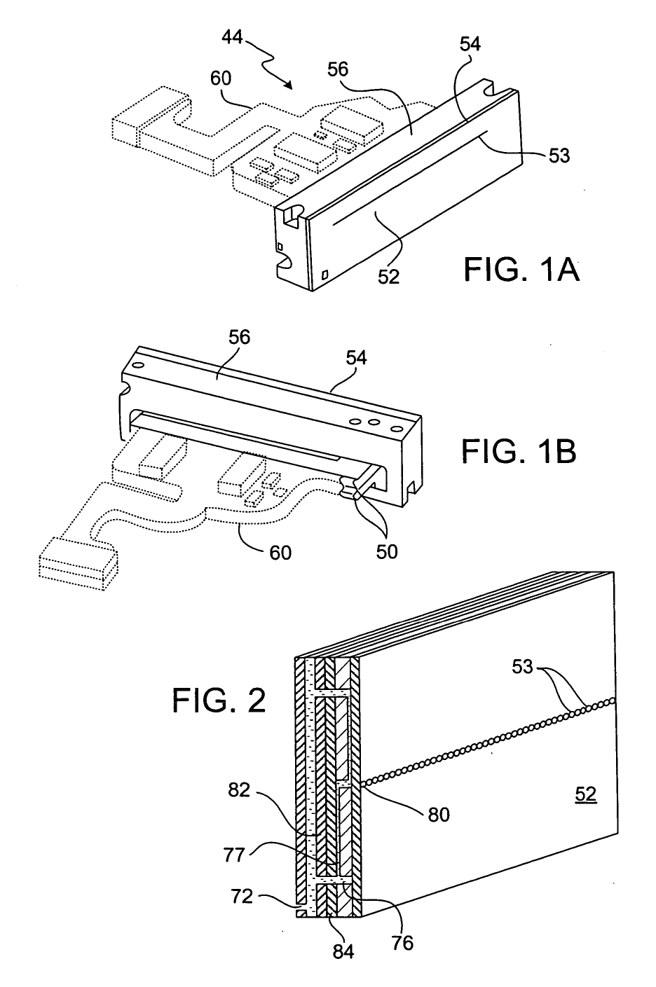

Referring FIG. 1, an apparatus 10 for printing on a substrate 12 includes an ink supply module 16 and a printing module 14 that is configured to jet an ink 25 that includes a radiation-curable material. Ink supply module 16 has an ink pathway 18 from an ink supply 21 to the printing module 14. The ink pathway 18 includes a first portion 20 that is configured to maintain the ink below a first temperature T₁, and a second portion 22 downstream of first portion 20 that is configured to heat the ink above first temperature T₁, e.g., at least about 25° C. above first temperature T₁, as it is conveyed (indicated by arrow 19) through second portion 22. In some implementations, first temperature T₁ is less than 50° C., e.g., less than 40° C., less than 30° C., less than 25° C., less than 15° C., or less than 5° C. In some embodiments, ink 25 is heated at least about 35° C. above first temperature T₁, e.g., at least 50° C. above T₁, at least 75° C. above T₁ or at least about 100° C. above first temperature T₁.

During conveyance of ink 25 through the second portion 22, little thermal polymerization of polymerizable ink components occurs during the heating. In some implementations, substantially no thermal polymerization of polymerizable components of the ink occurs during conveyance of the ink through the second portion 22, e.g., less that 0.05 percent by weight, e.g., less than 0.01, less than 0.005, less than 0.001, or less than 0.0001 percent by weight. Any thermal polymerization during conveyance of the ink can block ink flow pathways, nozzles, valves and/or filters, leading to a reduction in print quality.

Generally, the first temperature T₁ is chosen, e.g., such that little or no thermal polymerization occurs in the first portion 20 while the ink passes through the first portion.

Ink flow pathway 18 can be made permeable to air to allow for oxygenation of ink 25. In particular implementations, ink flow pathway 18 can include disks 41 of a semi-permeable material, e.g., expanded fluoropolymer material, along its length. The semi-permeable nature of the disk prevents ink from escaping from the ink flow pathway 18, but allows oxygen to pass through. Oxygen works in combination with inhibitors to reduce instabilities, e.g., premature thermal polymerization of ink components in flow pathway 18. In addition, ink flow pathway 18 can include filters 17, e.g., screen-type filters or sintered-type filters. Such filters can remove dust, debris and gels from the ink which can block ink flow pathways, nozzles, valves and/or filters, leading to a reduction in print quality. Such filters can also be located at other suitable locations along the ink flow pathways.

In the embodiment of FIG. 1, ink 25 is conveyed through ink supply module 16 utilizing an Archimedes' screw 30. Controller 32 manages the direction of rotation and the rotational speed of screw 30. After exiting portion 22 of ink pathway 18, the ink is delivered to a reservoir 40 in printing module 14, where the temperature of the ink is maintained at a suitable jetting temperature, e.g., greater than 75° C. In some instances, the heating of the ink in the second portion increases ink temperature exiting the second portion to a temperature that is within 15° C. of ink residing in the reservoir 40. This minimizes the possibility that the ink in reservoir 40 is thermally shocked by the ink entering from the ink supply module 16. The ink then travels along flow path 42 to printhead 44. Controller 46 controls the jetting of ink onto substrate 12, which is traveling below the printhead. Ink drop ejection is controlled by pressurizing ink with an actuator, which may be, for example, a piezoelectric actuator, a thermal bubble jet generator, or an electrostatically deflected element. Typically, printhead 44 has an array of ink paths with corresponding nozzle openings and associated actuators, such that drop ejection from each nozzle opening can be independently controlled. U.S. Pat. No. 5,265,315 describes a printhead that has a semiconductor body and a piezoelectric actuator. Piezoelectric inkjet printheads are described in U.S. Pat. Nos. 4,825,227, 4,937,598, 5,659,346, 5,757,391, and in U.S. Patent Application No. 2004/0004649 (now issued as U.S. Pat. No. 7,052,117). Ink on substrate 12, e.g., in the form of text or graphics, is cured with a radiation source 47, e.g., ultra-violet light or e-beam radiation. If UV radiation is used to cure the radiation-curable material, a wavelength of the light that cures the radiation-curable material is between about 200 nm and about 400 nm, e.g., a typical output from a medium pressure, metal-doped lamp, e.g., an iron-mercury lamp.

In a particular embodiment, ink 25 in supply 21 is maintained at about 25° C. During conveyance of ink 25 along pathway 18, ink 25 is maintained at about 25° C. in first portion 20, and then heated in second portion 22 so that the ink is approximately 75° C. when it exits the second portion 22 and enters reservoir 40 on printhead 14.

Referring now to FIGS. 1, 1A, 1B and 2, a more detailed description of the operation of a piezoelectric printhead 44 is provided. Piezoelectric inkjet printhead 44 includes jetting modules 50 and an orifice plate 52 with an array of orifice openings 53. The orifice plate 52 is mounted on a manifold 54, attached to a collar 56. The inkjet printhead 44 is controlled by electrical signals conveyed by flexprint elements 60 that are in electrical communication with controller 46 of print module 14.

Referring particularly to FIG. 2, in operation, ink flows from a reservoir (not shown) into a passage 72. The ink is then conveyed through passage 76 to a pressure chamber 77 from which it is ejected on demand through an orifice passageway 80 and a corresponding orifice 53 in the orifice plate 52 in response to selective actuation of an adjacent portion 82 of a piezoelectric actuator plate 84. Commercial inkjet printheads are available from Spectra, Inc., Hanover, N.H. (now the Spectra Printing Division of Dimatix, Inc).

Generally, suitable inks include colorants, polymerizable materials, e.g., monomers and/or oligomers, and photoinitiating systems. The polymerizable materials can be cross-linkable.

Colorants include pigments, dyes, or combinations thereof. In some implementations, inks include less than about 10 percent by weight colorant, e.g., less than 7.5 percent, less than 5 percent, less than 2.5 percent or less than 0.1 percent.

The pigment can be black, cyan, magenta, yellow, red, blue, green, brown, or a mixture these colors. Examples of suitable pigments include carbon black, graphite and titanium dioxide. Additional examples are disclosed in, e.g., U.S. Pat. No. 5,389,133.

Alternatively or in addition to the pigment, the inks can contain a dye. Suitable dyes include, e.g., Orasol Pink 5BLG, Black RLI, Blue 2GLN, Red G, Yellow 2GLN, Blue GN, Blue BLN, Black CN, and Brown CR, each being available from Ciba-Geigy. Additional suitable dyes include Morfast Blue 100, Red 101, Red 104, Yellow 102, Black 101, and Black 108, each being available from Morton Chemical Company. Other examples include, e.g., those disclosed in U.S. Pat. No. 5,389,133.

Mixtures of colorants may be employed.

Generally, the inks contain a polymerizable material, e.g., one or more polymerizable monomers. The polymerizable monomers can be mono-functional, di-functional, tri-functional or higher functional, e.g., penta-functional. The mono-, di- and tri-functional monomers have, respectively, one, two, or three functional groups, e.g., unsaturated carbon-carbon groups, which are polymerizable by irradiating in the presence of photoinitiators. In some implementations, the inks include at least about 40 percent, e.g., at least about 50 percent, at least about 60 percent, or at least about 80 percent by weight polymerizable material. Mixtures of polymerizable materials can be utilized, e.g., a mixture containing mono-functional and tri-functional monomers. The polymerizable material can optionally include diluents.

Examples of mono-functional monomers include long chain aliphatic acrylates or methacrylates, e.g., lauryl acrylate or stearyl acrylate, and acrylates of alkoxylated alcohols, e.g., 2-(2-ethoxyethoxy)-ethyl acrylate.

The di-functional material can be, e.g., a diacrylate of a glycol or a polyglycol. Examples of the diacrylates include the diarylates of diethylene glycol, hexanediol, dipropylene glycol, tripropylene glycol, cyclohexane dimethanol (Sartomer CD406), and polyethylene glycols.

Examples of tri- or higher functional materials include tris(2-hydroxyethyl)-isocyanurate triacrylate (Sartomer SR386), dipentaerythritol pentaacrylate (Sartomer SR399), and alkoxylated acrylates, e.g., ethoxylated trimethylolpropane triacrylates (Sartomer SR454), propoxylated glyceryl triacrylate, and propoxylated pentaerythritol tetraacrylate.

The inks may also contain one or more oligomers or polymers, e.g., multifunctional oligomers or polymers.

In some instances, the viscosity of the ink is between about 1 centipoise and about 50 centipoise, e.g., from about 5 centipoise to about 45 centipoise, or from about 7 centipoise to about 35 centipoise, at a temperature ranging from about 20° C. to about 150° C.

A photoinitiating system, e.g., a blend, in the inks is capable of initiating polymerization reactions upon irradiation, e.g., ultraviolet light irradiation.

The photoinitiating system can include, e.g., an aromatic ketone photoinitiator, an amine synergist, an alpha-cleavage type photoinitiator, and/or a photosensitizer. Each component is fully soluble in the monomers and/or diluents described above. Specific examples of the aromatic ketones include, e.g., 4-phenylbenzophenone, dimethyl benzophenone, trimethyl benzophenone (Esacure TZT), and methyl O-benzoyl benzoate.

An amine synergist can be utilized. For example, the amine synergist can be a tertiary amine. Specific examples of the amine synergists include, e.g., 2-(dimethylamino)-ethyl benzoate, ethyl 4-(dimethylamino) benzoate, and amine functional acrylate synergists, e.g., Sartomer CN384, CN373.

An alpha-cleavage type photoinitiator can be an aliphatic or aromatic ketone. Examples of the alpha-cleavage type photoinitiators include, e.g., 2,2-dimethoxy-2-phenyl acetophenone, 2,4,6-trimethylbenzoyl-diphenylphosphine oxide, and 2-methyl-1-[4-(methylthio)phenyl-2-morpholino propan-1-one (Irgacure 907).

A photosensitizer can be a substance that either increases the rate of a photoinitiated polymerization reaction or shifts the wavelength at which the polymerization reaction occurs. Examples of photosensitizers include, e.g., isopropylthioxanthone (ITX), diethylthioxanthone and 2-chlorothioxanthone.

The inks may contain an adjuvant such as a vehicle (e.g., a wax or resin), a stabilizer, an oil, a flexibilizer, or a plasticizer. The stabilizer can, e.g., inhibit oxidation of the ink. The oil, flexibilizer, and plasticizer can reduce the viscosity of the ink.

Examples of waxes include, e.g., stearic acid, succinic acid, beeswax, candelilla wax, carnauba wax, alkylene oxide adducts of alkyl alcohols, phosphate esters of alkyl alcohols, alpha alkyl omega hydroxy poly(oxyethylene), allyl nonanoate, allyl octanoate, allyl sorbate, allyl tiglate, bran wax, paraffin wax, microcrystalline wax, synthetic paraffin wax, petroleum wax, cocoa butter, diacetyl tartaric acid esters of mono and diglycerides, alpha butyl omega hydroxypoly(oxyethylene)poly(oxypropylene), calcium pantothenate, fatty acids, organic esters of fatty acids, amides of fatty acids (e.g., stearamide, stearyl stearamide, erucyl stearamide (e.g., Kemamide S-221 from Crompton-Knowles/Witco), calcium salts of fatty acids, mono & diesters of fatty acids, lanolin, polyhydric alcohol diesters, oleic acids, palmitic acid, d-pantothenamide, polyethylene glycol (400) dioleate, polyethylene glycol (MW 200-9,500), polyethylene (MW 200-21,000); oxidized polyethylene; polyglycerol esters of fatty acids, polyglyceryl phthalate ester of coconut oil fatty acids, shellac wax, hydroxylated soybean oil fatty acids, stearyl alcohol, and tallow and its derivatives.

Examples of resins include, e.g., acacia (gum arabic), gum ghatti, guar gum, locust (carob) bean gum, karaya gum (sterculia gum), gum tragacanth, chicle, highly stabilized rosin ester, tall oil, manila copais, corn gluten, coumarone-indene resins, crown gum, damar gum, dimethylstyrene, ethylene oxide polymers, ethylene oxide/propylene oxide copolymer, heptyl paraben, cellulose resins, e.g., methyl and hydroxypropyl; hydroxypropyl methylcellulose resins, isobutylene-isoprene copolymer, polyacrylamide, functionalized or modified polyacrylamide resin, polyisobutylene, polymaleic acid, polyvinyl acetate, polyvinyl alcohol, polyvinyl pyrrolidone, rosin, pentaerythritol ester, purified shellac, styrene terpolymers, styrene copolymers, terpene resins, turpentine gum, zanthan gum and zein.

Examples of stabilizers, oils, flexibilizers and plasticizers include, e.g., methylether hydroquinone (MEHQ), hydroquinone (HQ), butylated hydroxyanisole (BHA), butylated hydoxytoluene (BHT), propyl gallate, tert-butyl hydroquinone (TBHQ), ethylenediaminetetraacetic acid (EDTA), methyl paraben, propyl paraben, benzoic acid, glycerin, lecithin and modified lecithins, agar-agar, dextrin, diacetyl, enzyme modified fats, glucono delta-lactone, carrot oil, pectins, propylene glycol, peanut oil, sorbitol, brominated vegetable oil, polyoxyethylene 60 sorbitan monostearate, olestra, castor oil; 1,3-butylene glycol, coconut oil and its derivatives, corn oil, substituted benzoates, substituted butyrates, substituted citrates, substituted formats, substituted hexanoates, substituted isovalerates, substituted lactates, substituted propionates, substituted isobutyrates, substituted octanoates, substituted palmitates, substituted myristates, substituted oleates, substituted stearates, distearates and tristearates, substituted gluconates, substituted undecanoates, substituted succinates, substituted gallates, substituted phenylacetates, substituted cinnamates, substituted 2-methylbutyrates, substituted tiglates, paraffinic petroleum hydrocarbons, glycerin, mono- and diglycerides and their derivatives, polysorbates 20, 60, 65, 80, propylene glycol mono- and diesters of fats and fatty acids, epoxidized soybean oil and hydrogenated soybean oil.

Additional inks have been described by Woudenberg in Published U.S. Patent Application No. 2004/0132862 (now issued as U.S. Pat. No. 6,896,937).

In some embodiments, the inks used are hybrid-F UV curable jetting inks and the printhead used is the SureFire 65™ printhead.

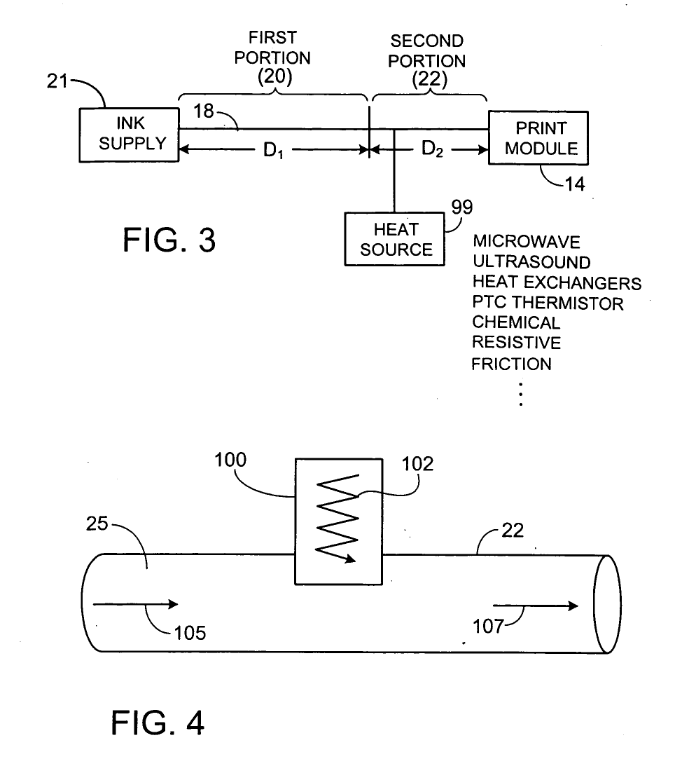

Referring now to FIG. 3, ink is heated in the second portion 22 of ink pathway 18 using a heat source 99 as the ink is conveyed from the ink supply 21 to the print module 14. The heating of the ink can be accomplished with, e.g., RF energy, microwaves, ultrasound, heat exchangers, e.g., thin-walled heat exchangers, PTC thermistors or resistive heating elements. Ink can also be heated, e.g., using frictional heating, or by chemical means.

To minimize thermal polymerization of ink components during heating in second portion 22 of ink flow pathway 18, a residence time of the ink being conveyed through the second portion is less than 60 minutes, e.g., less than 30 minutes, less than 15 minutes, or less than 5 minutes.

In addition, to reduce thermal polymerization of ink components during heating in second portion 22 of ink flow pathway 18, a ratio of a distance D₁ traveled by the ink through the first portion 20 to a distance D₂ traveled by the ink in the second portion 22 is greater than about 50 to 1, e.g., greater than 60 to 1, greater than 75 to 1, greater than 100 to 1, greater than 200 to 1 or greater than 250 to 1.

In some embodiments, a viscosity of the ink in the pressure chamber is not more than fifty percent higher than the initial viscosity of the ink in the ink supply, both viscosities being measured at jetting temperature. For example, in some embodiments, the viscosity of the ink in the pressure chamber is not more than twenty five percent higher than the initial viscosity, e.g., not more than ten percent higher than the initial viscosity, or not more than five percent higher than the initial viscosity.

Referring now to FIG. 4, a hermetically-sealed microwave transmitter 100 emits microwaves 102, e.g., having a frequency of between about 0.5 GHz and 41.0 GHz, e.g., 1 GHz, 3 GHz, 6 GHz, 25 GHz or more, e.g., 40 GHz, as ink 25 flows through second portion 22, as indicated by arrows 105 and 107. Ink 25 absorbs the microwave energy and converts it to heat, increasing the temperature of the ink. Since dipolar polarization is largely responsible for the majority of microwave heating effects, adding electrically conductive and/or magnetic materials to the ink can improve heating efficiency. For example, the electrically conductive and/or magnetic materials used to improve heating efficiency can be in the form of particles or fibers. Specific particles include particles of iron, stainless steel or nickel. Specific fibers include carbon fibers, nickel coated carbon fibers and steel coated wool fibers. Additional materials and material sizes are described in U.S. Pat. No. 6,677,559.

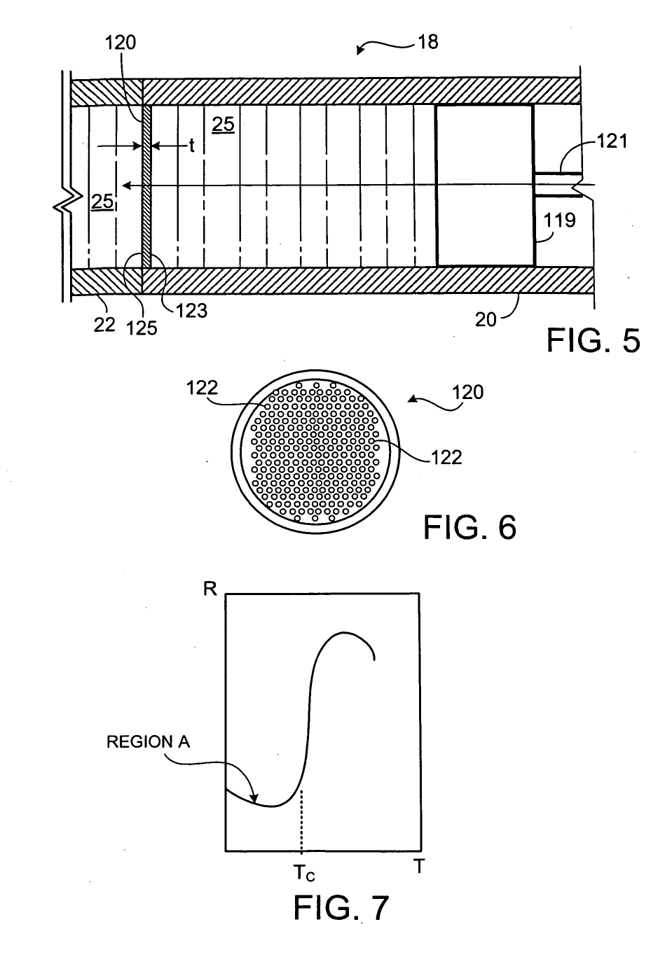

Ink 25 can also be heated by frictional heating. For example, referring to FIGS. 5 and 6, ink 25 is conveyed from first portion 20 of ink pathway 18 to second portion 22 of ink pathway 18 by a plunger 119 driven by rod 121. Positioned at the start of second portion 22 is a disk 120 that has a plurality flow openings 122 defined therein. Ink enters into flow openings 122 on a first side 123, and then flows through disk 120 along a plurality of torturous flow paths, finally exiting far side 125 of disk 120 at a higher temperature due to shear heating. In some embodiments, the flow openings have a maximum dimension of less than 5 micron, e.g., less than 3 micron, less than 2 micron, less than 1 micron, or less than 0.5 micron. In some implementations, pressure generated by the plunger as the ink flows through disk 120 is greater than 10,000 psi, e.g., greater than 20,000 psi, greater than 30,000 psi, or greater than 50,000 psi. In some embodiments, a thickness (t) of disk 120 is between about 0.025 inch to about 0.50 inch, e.g., 0.050 inch, 0.10 inch or more, e.g., 0.25 inch.

PTC thermistor heating elements are suitable as heat sources for heating the ink as it is conveyed through second portion 22. Since electrical resistance through the PTC thermistor rapidly increases above a critical temperature T_{c}, effectively “turning off” heating, PTC thermistors can be used as “self-regulating” heating elements.

Referring to FIG. 7, with increasing temperature, the resistance to electrical current through a PTC thermistor initially decreases (Region A), and then rises exponentially when the temperature is greater than the critical temperature T_{c} of the PTC thermistor. Above the critical temperature, resistance to electrical current is high enough to shut down current flow through the device along with heating, preventing “run-away” temperatures. PTC thermistors are commercially available that have a variety of critical temperatures T_{c}, e.g., critical temperatures of 50° C., 60° C., 70° C., 80° C., 90° C., 110° C., 130° C. or more, e.g., 220° C. Suitable PTC thermistors are available from EPCOS, Munich, Germany.

In a particular embodiment, a plurality of PTC thermistors are utilized so that the heating of the ink in second portion 22 is performed progressively such that the increase in temperature is it travels through second portion 22.

In some embodiments, rather than using PTC thermistors to heat the ink, resistive heating elements, e.g., such ceramic resistive heating elements are used, which are available from DATEC.

Chemical agents added to the ink stream can react with the ink to generate heat. Heat is generated by bond-breaking or bond formation. Suitable chemical agents include metals or salts.

In some implementations, the heat source is traversed between opposite ends of second portion 22 to improve heating efficiency.

High intensity, focused ultrasonic probes are suitable as heat sources for heating the ink as it is conveyed through second portion 22. Ultrasonic probes can also be used advantageously to mix and emulsify the ink, e.g., to improve color-blending. Suitable ultrasonic probes have been described in U.S. Pat. Nos. 5,573,497, 5,743,863 and 6,626,855.

### Other Embodiments

While certain embodiments have been described, other embodiments are possible.

While the embodiment of FIG. 1 utilizes a single color ink, in some embodiments, a devices and methods described utilize ink handling systems in which more than one color of ink is conveyed, e.g., two, three, four, five, six, seven or more, e.g., ten.

While the embodiment of FIG. 1 illustrates an ink pathway that has a first portion and a second portion, in some embodiments, the ink flow pathway has only a single portion.

While inks have been discussed, the devices and methods disclosed are suitable for other jetting materials, e.g., clear overcoat materials, or flavors and/or fragrances.

Other embodiments are within the scope of the following claims.

What we claim is:

1. A method of handling an ink, the method comprising:
conveying an ink having an initial viscosity and comprising a radiation-curable material along an ink pathway from an ink supply to a jetting module comprising a pressure chamber; and
pressurizing the pressure chamber to eject ink from the jetting module,
wherein a viscosity of the ink in the pressure chamber is not more than fifty percent higher than the initial viscosity, both viscosities being measured at jetting temperature.

2. The method of claim 1, wherein the viscosity of the ink in the pressure chamber is not more than twenty five percent higher than the initial viscosity.

3. The method of claim 1, wherein the radiation curable material is selected from the group consisting of (2-hydroxyethyl)-isocyanurate triacrylate, dipentaerythritol pentaacrylate, ethoxylated trimethylolpropane triacrylates, propoxylated glyceryl triacrylate, propoxylated pentaerythritol tetraacrylate, and mixtures thereof.

4. The method of claim 1, wherein the conveying is performed with a screw.

5. The method of claim 1, wherein the heating is performed with ultrasound.

6. The method of claim 1, wherein the heating is performed with microwaves.

7. The method of claim 1, wherein the heating is performed with a resistive material.

8. The method of claim 1, wherein the heating is performed with a PTC thermistor.

9. The method of claim 1, wherein the heating is performed by friction.

10. The method of claim 1, wherein the radiation that cures the radiation-curable material is ultraviolet light.

11. A method of handling an ink, the method comprising:
conveying an ink comprising a radiation-curable material along an ink pathway from an ink supply to a jetting module comprising a pressure chamber; and
pressurizing the pressure chamber to eject ink from the jetting module,
wherein a residence time of the ink, measured from the ink supply to the pressure chamber is less than about four hours.

12. The method of claim 11, wherein the viscosity of the ink in the pressure chamber is not more than twenty five percent higher than an initial viscosity.

13. The method or apparatus of claim 11, wherein the radiation-curable material is selected from the group consisting of (2-hydroxyethyl)-isocyanurate triacrylate, dipentaerythritol pentaacrylate, ethoxylated trimethylolpropane triacrylates, propoxylated glyceryl triacrylate, propoxylated pentaerythritol tetraacrylate, and mixtures thereof.

14. The method of claim 11, wherein the conveying is performed with a screw.

15. The method of claim 11, wherein the heating is performed with ultrasound.

16. The method of claim 11, wherein the heating is performed with microwaves.

17. The method of claim 11, wherein the heating is performed with a resistive material.

18. The method of claim 11, wherein the heating is performed with a PTC thermistor.

19. The method of claim 11, wherein the heating is performed by friction.

20. The method of claim 11, wherein the radiation that cures the radiation-curable material is ultraviolet light.

21. A method of handling an ink, the method comprising:
conveying an ink comprising a radiation-curable material along an ink pathway from an ink supply to a printing module, the ink pathway comprising a first portion configured to maintain the ink below a first temperature, and a second portion downstream of the first portion configured to heat the ink above the first temperature; and
heating the ink in the second portion such that substantially no thermal polymerization of the ink occurs during the heating in the second portion.

22. The method of claim 21, wherein the radiation-curable material is selected from the group consisting of (2-hydroxyethyl)-isocyanurate triacrylate, dipentaerythritol pentaacrylate, ethoxylated trimethylolpropane triacrylates, propoxylated glyceryl triacrylate, propoxylated pentaerythritol tetraacrylate, and mixtures thereof.

23. The method of claim 21, wherein the conveying is performed with a screw.

24. The method of claim 21, wherein the heating of the ink in the second portion increases ink temperature exiting the second portion to a second temperature that is within 10° C. of ink residing in a reservoir of the printing module.

25. The method of claim 21, wherein the heating is performed with ultrasound.

26. The method of claim 21, wherein the heating is performed with a thin-walled heat exchanger.

27. The method of claim 21, wherein the heating is performed with microwaves.

28. The method of claim 21, wherein the heating is performed with a resistive material.

29. The method of claim 21, wherein the heating is performed with a PTC thermistor.

30. The method of claim 21, wherein the heating is performed by friction.

31. The method of claim 21, wherein the radiation that cures the radiation-curable material is ultraviolet light.

32. The method of claim 21, wherein a ratio of a distance traveled by the ink through the first portion to a distance traveled by the ink in the second portion is greater than about 100 to 1.
